(19) United States
(12) Patent Application Publication
(10) Pub. No.: US 2025/0267527 A1
(43) Pub. Date: Aug. 21, 2025

(54) CELL DETECTION METHOD AND APPARATUS THEREOF

(71) Applicant: MEDIATEK INC., Hsinchu City (TW)

(72) Inventors: Er-Ya LEE, Hsinchu City (TW); Tz-yuan SHIU, Hsinchu City (TW)

(21) Appl. No.: 19/049,288

(22) Filed: Feb. 10, 2025

Related U.S. Application Data
(60) Provisional application No. 63/554,261, filed on Feb. 16, 2024.

(51) Int. Cl. H04W 36/00; H04W 36/08

(52) U.S. Cl. CPC H04W 36/0058; H04W 36/08

(57) ABSTRACT

A cell detection method is provided. The cell detection method may be applied to an apparatus. The cell detection method may include the following steps. The apparatus may receive a parameter configuration from a network node. Then, the apparatus may perform a measurement according to the parameter configuration to obtain timing information associated with the apparatus and the network node for a period of time. Then, the apparatus may perform a velocity estimation according to the timing information. Then, the apparatus may perform at least one prediction operation or detection operation according to a result of the velocity estimation to select a target cell. Then, the apparatus may transmit a measurement report associated with the target cell to the network node.

### CROSS REFERENCE TO RELATED APPLICATIONS

This application claims the benefits of U.S. Provisional Application No. 63/554,261 filed on Feb. 16, 2024, the entirety of which is incorporated by reference herein.

### BACKGROUND OF THE INVENTION

### Field of the Invention

The invention generally relates to cell detection and network selection technology, and more particularly, it relates to cell detection and network selection based on cell timing information.

### Description of the Related Art

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

In conventional technologies, a user equipment (UE) may determine a target cell for hand over or cell selection only according to the signal quality of the cell (e.g., a reference signal received power (RSRP) value, a reference signal received quality (RSRQ) value, and a signal to interference plus noise ratio (SINR) value of the cell). Therefore, unnecessary handover (e.g., ping-pong handover) may occur, and the timing of the handover may be not accurate enough.

Therefore, how to more accurately perform cell detection for handover or cell reselection is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to cell detection with respect to user equipment (UE) and network apparatus in mobile communications. It is believed that the above-described issue would be avoided or otherwise alleviated by implementing one or more of the proposed schemes described herein.

An embodiment of the invention provides a cell detection method. The cell detection method may be applied to an apparatus. The cell detection method may include the following steps. The apparatus may receive a parameter configuration from a network node. Then, the apparatus may perform a measurement according to the parameter configuration to obtain timing information associated with the apparatus and the network node for a period of time. Then, the apparatus may perform a velocity estimation according to the timing information. Then, the apparatus may perform at least one prediction operation or detection operation according to the result of the velocity estimation to select a target cell. Then, the apparatus may transmit a measurement report associated with the target cell to the network node.

According to some embodiments, the timing information may comprise at least one of a downlink (DL) signal received timing, an uplink (UL) timing advance and a Doppler shift.

According to some embodiments, the result of the velocity estimation may comprise a speed magnitude, a moving direction and a slope information.

According to some embodiments, the at least one prediction operation may comprise a weak field prediction and a coverage hole prediction.

According to some embodiments, the at least one detection operation may comprise scenario detection, wherein the result of the scenario detection may comprise a fixed trajectory scenario or a non-fixed trajectory scenario.

According to some embodiments, the at least one prediction operation comprises a target cell prediction for a handover or a cell reselection.

According to some embodiments, the apparatus may perform the target cell prediction according to the result of the velocity estimation, the result of the scenario detection and signal quality information. The signal quality information may comprise at least one of a reference signal received power (RSRP) value, a reference signal received quality (RSRQ) value, and a signal to interference plus noise ratio (SINR) value.

According to some embodiments, the apparatus may a timing prediction for the handover or the cell reselection.

An embodiment of the invention provides an apparatus for cell detection. The apparatus may include a transceiver and a processor. The transceiver may wirelessly communicate with a network node. The processor is coupled to the transceiver. The processor may be configured to receive, via the transceiver, a parameter configuration from the network node. The processor may be also configured to perform a measurement according to the parameter configuration to obtain timing information associated with the apparatus and the network node for a period of time. The processor may be further configured to perform a velocity estimation according to the timing information. The processor may be further configured to perform at least one prediction operation or detection operation according to the result of the velocity estimation to select a target cell. The processor may be further configured to transmit, via the transceiver, a measurement report associated with the target cell to the network node.

Another embodiment of the invention provides a cell detection method. The cell detection method may be applied to a network node. The cell detection method may comprise the following steps. The network node may transmit a parameter configuration to a user equipment. Then, the network node may receive a measurement report associated with a target cell from the UE. The target cell may be selected according to the result of the velocity estimation associated with timing information which is obtained according to the parameter configuration. Then, according to the measurement report, the network node may indicate the UE to perform a handover operation to hand over to the target cell.

Other aspects and features of the invention will become apparent to those with ordinary skill in the art upon review of the following descriptions of specific embodiments of the cell detection method and apparatus for vehicle detection.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating a network node according to an embodiment of the application.

FIG. 4 is a schematic diagram illustrating a cell timing according to an embodiment of the invention.

FIG. 5 is a schematic diagram illustrating a cell timing according to another embodiment of the invention.

FIG. 6 is a flow chart illustrating a cell detection method according to an embodiment of the invention.

FIG. 7 is a flow chart illustrating a cell detection method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

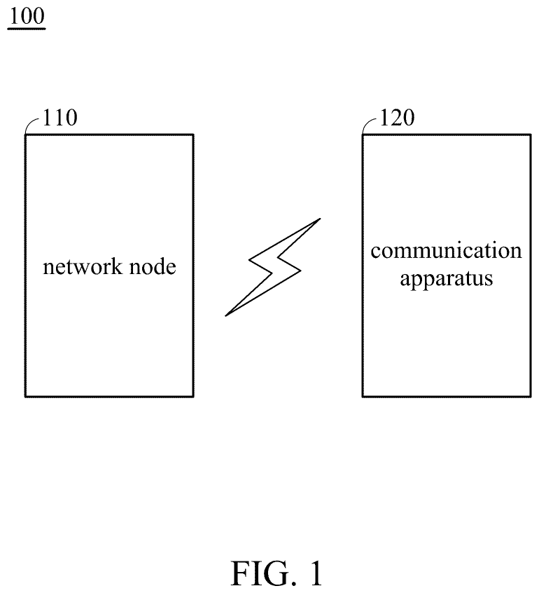

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point, an access terminal, but the invention should not be limited thereto. In the embodiment, the communication apparatus 120 may communicate with the network node 110 through the fourth generation (4G) communication technology, fifth generation (5G) communication technology (or 5G New Radio (NR) communication technology), or sixth generation (6G) communication technology, but the invention should not be limited thereto.

In the embodiments of the invention, the communication apparatus 120 may be user equipment (UE), a smartphone, Personal Data Assistant (PDA), pager, laptop computer, desktop computer, wireless handset, or any computing device that includes a wireless communications interface. In the embodiments of the invention, the communication apparatus 120 may be located in a vehicle, e.g., subway, metro, train, high speed train (HST), and so on.

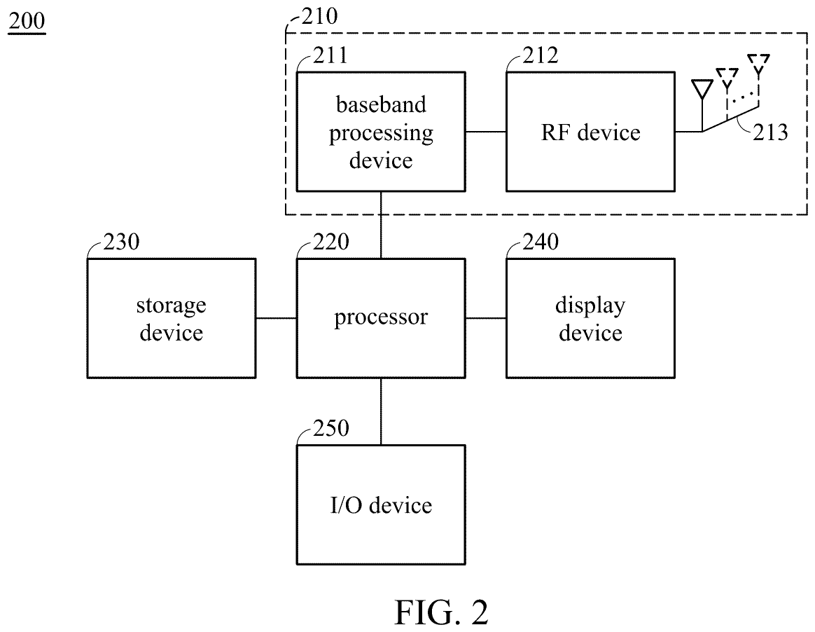

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, and an Input/Output (I/O) device 250.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2.

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, and the I/O device 250 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the wireless transceiver 210 may be configured in a modem (MD) of the communication apparatus 200, and the processor 220 may be configured in an application processor (AP) of the communication apparatus 200.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

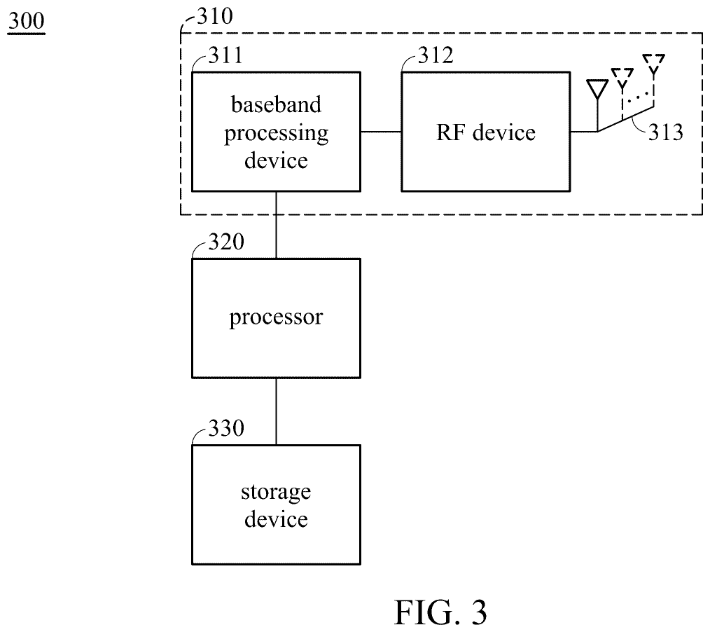

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.,

The processor 320 may be a general-purpose processor, an MCU, an application processor, a DSP, a GPH/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, an apparatus (e.g., communication apparatus 120) may receive a parameter configuration from a network node (e.g., network node 110). The parameter configuration may comprise reference signals (e.g., synchronization signal block (SSB) and channel state information-reference signal (CSI-RS)), timing advance (TA), and so on. The apparatus may perform a measurement according to the parameter configuration to obtain timing information associated with the apparatus and the network node for a period of time. In addition, the apparatus may perform a velocity estimation according to the timing information. Then, the apparatus may perform at least one prediction operation or detection operation according to the result of the velocity estimation to select a target cell. In addition, the apparatus may transmit a measurement report associated with the target cell to the network node.

According to an embodiment of the invention, the timing information may comprise at least one of a downlink (DL) signal received timing, an uplink (UL) timing advance and a Doppler shift.

According to an embodiment of the invention, the result of the velocity estimation may comprise a speed magnitude, a moving direction and a slope information.

According to an embodiment of the invention, when the apparatus performs the velocity estimation, the apparatus may use the signal propagation delay (e.g., the change rate of TA, i.e., ATA) which depends on the distance between the network node and apparatus to obtain the relative position and velocity (i.e., moving direction and speed) of the apparatus with respect to the network node. Specifically, the apparatus may analyze or perform calculation for the timing information (e.g., received timing of periodic DL reference signals (e.g., SSB and CSI-RS), UL TA, Doppler spectrum, or the combinations of the above) over a period of observation time to obtain the result of the velocity estimation (i.e., the relative position and velocity (i.e., moving direction and speed) of the apparatus with respect to the network node). The apparatus may store and use the derived results (e.g., moving direction and speed) of the velocity estimation to enhance mobility decisions and user experience.

In an implementation of the invention, an earlier DL received timing or smaller UL TA may refer to a shorter distance between the apparatus and the network node. The change rate of DL signal received timing or UL TA may be directly proportional to the velocity (i.e., v) of the apparatus relative to the source (i.e., the network node) of the signal and the cosine of the angle (i.e., cos 0) between the direction of the motion of the apparatus and the line of sight to the source (i.e., the signal from the network node). It can be expressed by the following formula:

$$[ v \times cos θ = \frac{Δ propogation delay ( or Δ TA )}{Δ t} \times c ] , \\ where \\ \frac{Δpropogation delay ( or Δ TA )}{Δ t}$$

is the change rate of DL signal received timing or UL TA, v is the velocity of the apparatus, c is the speed of light, θ is the angle between the direction of the motion of the apparatus and the line of sight to the network node. The positive change rate (e.g., the slope of the cell timing of the current serving cell is positive) of the DL signal received timing or UL TA (i.e., the DL signal received timing or UL TA is increasing over time) may indicate that the apparatus is moving away from the network node. The negative change rate (e.g., the slope of the cell timing of a target cell is negative) of the DL signal received timing or UL TA (i.e., the DL signal received timing or UL TA is decreasing over time) may indicate that the apparatus is approaching the network node. If the moving direction of the apparatus is perpendicular to the line of sight to the network node (i.e., θ=90° or) 270°, there will be no DL signal received timing or UL IA change

$$( i . e . , \frac{Δpropogation delay ( or Δ TA )}{Δ t} = 0 ) .$$

In another implementation of the invention, the Doppler frequency shift (i.e., f_d) may be directly proportional to the velocity (v) of the apparatus relative to the source (i.e., the network node) of the signal and the cosine of the angle (i.e., cos 0) between the direction of the motion of the apparatus and the line of sight to the source (i.e., the signal from network node). It can be expressed by the following formula:

$$[ f\_d = \frac{v}{c} \times f\_c \times cos θ ) ] ,$$

where f_d is the Doppler frequency shift, v is the velocity of the apparatus, c is the speed of light, f_c is the carrier frequency of the transmitted signal, θ is the angle between the direction of the apparatus motion and the line of sight to the network node. A negative Doppler frequency shift may indicate that apparatus is moving away from the network node. A positive Doppler frequency shift may indicate that apparatus is approaching the network node. If the moving direction of the apparatus is perpendicular to the line of sight to the network node (i.e., θ=90° or 270°), there will be no Doppler shift (i.e., f_d=0).

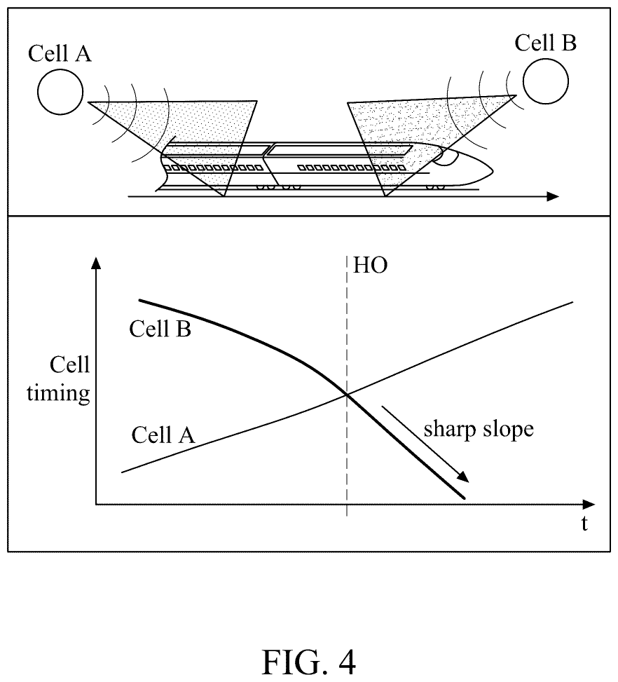

FIG. 4 is a schematic diagram illustrating cell timing according to an embodiment of the invention. As shown in FIG. 4, the apparatus first obtains cell timing information corresponding to cell A (e.g., source cell or serving cell) and cell B (e.g., target cell) to assist in velocity estimation. The cell timing of cell A is observed to be increasing over time, indicating that the distance between the apparatus and cell A is increasing. This observation corresponds to a positive and sharp slope in the cell timing value of cell A. Consequently, it can be inferred that the apparatus is moving away from cell A at a certain velocity. Conversely, the cell timing value of cell B is observed to be decreasing over time, indicating that the distance between the apparatus and cell B is decreasing. This observation corresponds to a negative and sharp slope in the cell timing value of cell B. Therefore, it can be inferred that the apparatus is approaching cell B (i.e., the target cell) at a certain velocity. Therefore, according to the result of the velocity estimation, the apparatus can determine the target cell for handover or cell reselection more accurately.

According to an embodiment of the invention, the at least one prediction operation may comprise a weak field prediction and a coverage hole prediction. Specifically, the weak field and the coverage hole of a given frequency or radio access technology (RAT) may comprise the DL weak field, the UL weak field, the DL coverage hole, and the UL coverage hole. The apparatus may predict that there is a UL weak field in an event that the UL TX power achieves the maximum, the UL assignment resource block (RB) number assigned by network node is below a predefined threshold, the modulation and coding scheme (MCS) assigned by network node is below a predefined threshold, and/or the number of layers assigned by network node is below a predefined threshold. The UL coverage hole may be referred as the exact definition of the weak field, except that the thresholds used for the weak field is higher than the thresholds used for the coverage hole, and the apparatus is moving away from all cells. The apparatus may predict that there is a DL weak field in an event that the best RSRP and/or SINR among all cells for the given frequency, or the given RAT falls below a predefined threshold. The DL coverage hole may be referred as the exact definition of the weak field, except that the RSRP and/or SINR threshold used for the weak field is higher than the RSRP and/or SINR threshold used for the coverage hole, and the apparatus is moving away from all cells.

In an example, the apparatus may predict that there is an intra-frequency DL coverage hole in an event that the best RSRP and/or SINR among the serving and all the intra-frequency neighboring cells falls below a predefined threshold, and the apparatus is moving away from the serving and all the intra-frequency neighboring cells.

In another example, the apparatus may predict that there is an intra-frequency UL coverage hole in an event that the UL TX power achieves maximum and the UL assignment RB number assigned by NW is below a predefined threshold, the MCS assigned by NW is below a predefined threshold, and/or the number of Layers assigned by NW is below a predefined threshold, and the apparatus is moving away from the serving and all the intra-frequency neighboring cells.

In another example, the apparatus may predict that there is an NR or LTE DL coverage hole in an event that the best RSRP and/or SINR among the serving and all the intra-frequency and inter-frequency neighboring cells falls below a predefined threshold and the apparatus is moving away from the serving and all the intra-frequency and inter-frequency neighboring cells.

According to an embodiment of the invention, the at least one detection operation may comprise scenario detection. The result of the scenario detection may comprise a fixed trajectory scenario or a non-fixed trajectory scenario. Specifically, the apparatus may use the result (e.g., speed magnitude and moving direction) of the velocity estimation for the scenario detection. The scenarios may be categorized as scenario (1) in which the apparatus may be moving along a fixed trajectory (e.g., high-speed train (HST), train, subway, highway), and scenario (2) in which the apparatus may be moving along a non-fixed trajectory (e.g., urban driving, walking). For the scenario (1), the network deployments may be primarily aligned with the paths corresponding to the fixed trajectories, and the apparatus may move in a consistent direction along the paths. For the scenario (1), a mechanism is employed where scenario (2) is determined if scenario (1) is not detected.

In an embodiment, the apparatus may determine that the scenario (1) is detected according to at least one of the following conditions. In an example, the condition may be that there is a “triangular-wave-like DL signal received timing” pattern. In another example, the condition may be that the estimated speed is within a specified range. In another example, the condition may be that the apparatus is approaching one cell and/or leaving another cell with a similar speed. The “triangular-wave-like DL signal received timing” pattern may defined as the change rate of DL signal received timing or UL TA of a cell alternates between linearly falling and rising slopes (i.e., the apparatus is first moving toward, pass by, then moving away from a cell deployed along the fixed trajectory, which corresponds to a linear decrease, transition, and a linear increase of DL signal received timing or UL TA of the cell). The repetition of the pattern may be equal to the number of remote radio heads (RRHs) of the base station, as seen in deployments like dynamic point switching (DPS) or single frequency network (SFN) for HST.

In an example, for the single cell scenario, the “triangular-wave-like DL signal received timing” pattern may be defined as the change rate of DL signal received timing or UL TA of the target cell alternates between linearly falling and rising slopes (i.e., the apparatus is first moving toward, pass by, then moving away from the cell deployed along the fixed trajectory, which corresponds to a linear decrease, transition, and a linear increase of DL signal received timing or UL TA of the target cell).

In another example, for the multiple cells (i.e., handover and reselection) scenario, the “triangular-wave-like DL signal received timing” pattern may be defined as the change rate of DL signal received timing or UL TA of the current and the next serving cell alternates between linearly falling and rising slopes (i.e., the apparatus is first moving toward, pass by, then moving away from the cell deployed along the fixed trajectory, which corresponds to a linear decrease, transition, and a linear increase of DL signal received timing or UL TA of the cell), and the cell timing of the current and the next serving cell crosses with the change rate of DL signal received timing or UL TA of the target and the source cell being linearly falling and increasing slopes, respectively, at the cell boundary.

For scenario (1), different transportation types may be further distinguished based on the speed estimation characteristics of the apparatus when approaching and departing stations. The HST, subway, and train scenarios may be differentiated from the highway scenario by observing whether the speed estimation of the apparatus remains constant (or the variation of the estimated speed is within a small range) most of the time and drops to zero for a period similar to the average station dwell time. The HST, subway, and train scenarios may be further differentiated by the average speed estimation results.

For HST, train, and subway scenarios, the indicators for detecting whether the train is approaching or departing a station may be determined according to the speed estimation results. The approach of the train to a station may be indicated by a drop in the estimated speed from a constant (or the variation of the estimated speed is within a small range) to zero. The departure of the train may be indicated by an increase in the estimated speed from zero to a constant (or the variation of the estimated speed is within a small range). The apparatus may transmit the indicators to the network node for application enhancements. For scenario (1), the cells may be categorized as the along-fixed-trajectory cells or non-along-fixed-trajectory cells. An along-fixed-trajectory cell, typically located close to the fixed path corresponding to the apparatus, may be detected by the presence of the “triangular-wave-like DL signal received timing” pattern. Conversely, a non-along-fixed-trajectory cell may be detected when this pattern is absent.

In order to increase the detection accuracy, additional measures may be taken to ensure that the average estimated speed of the apparatus falls within predefined ranges corresponding to different transportation types.

According to an embodiment of the invention, the at least one prediction operation may comprise a target cell prediction for a handover or a cell reselection. The apparatus may perform the target cell prediction according to the result of the velocity estimation, the result (e.g., the moving direction) of the scenario detection and signal quality information. The signal quality information may comprise at least one of a reference signal received power (RSRP) value, a reference signal received quality (RSRQ) value, and a signal to interference plus noise ratio (SINR) value.

In conventional handover operation, the handover is determined only based on RSRP and/or SINR. Therefore, it may lead to issues such as a ping-pong handover, a too late handover, a handover failure, or a radio link failure (RLF). Therefore, in order to enhance mobility robustness, in the embodiments of the invention, multiple results may be jointly considered for the target cell prediction for the handover or cell reselection. The results may comprise quality information (e.g., RSRP/RSRQ/SINR), the result of the velocity estimation (e.g., moving direction), and the result of the scenario detection, but the invention should not be limited thereto.

In an embodiment, a neighbor cell may be predicted as a target cell for handover in an event that the apparatus is moving toward that cell and away from the serving cell, the RSRP/SINR of the neighbor cell exceeds a predefined threshold, and/or the RSRP/SINR difference between the serving cell and neighboring cell is below a predefined threshold.

In another embodiment, when scenario (1) is detected, the apparatus may move along the fixed trajectories (e.g., high-speed train, train, subway, highway), and the identified along-fixed-trajectory cells may be considered as the potential target cells for handover. That is, the non-along-fixed-trajectory cells may not be considered as the target cells for handover if any along-fixed-trajectory cells with RSRP and/or SINR above a predefined threshold are detected. Therefore, the method of the embodiment can avoid handing over to the non-along-fixed-trajectory cells. Therefore, unnecessary handovers and the risk of RLF can be reduced.

According to an embodiment of the invention, the apparatus may perform a timing prediction for the handover or the cell reselection. According to an embodiment of the invention, based on the target cell prediction results, the timing for handover and reselection may be predicted by considering at least one of the following factors. The factors may comprise the moment of the distance from the apparatus to the serving cell and the distance from the apparatus to the target cell being approximately equal. The factors may also comprise the absolute RSRP/RSRQ/SINR values of the serving cell and target cell. The factors may also comprise the RSRP/RSRQ/SINR difference between the serving cell and the target cell. The factors may also comprise the link path loss and the TX power difference (between the serving cell and target cell) of the network node. More than one aforementioned factor may be combined to mitigate the impact of TX power differences of the network node (e.g., between macro cells and micro cells).

The apparatus may determine the moment of the distance from the apparatus to the serving and the distance from the apparatus to target cell being approximately equal (e.g., similar DL reference signal timings) according to the timing change rate and the timing difference between the serving and target cells.

The TX power of the network node may be referred to the reference signal power configured by the network node through the system information block 1 (SIB1) or SIB2 for NR or LTE, respectively. The pathloss estimation may be calculated by subtracting the measured RSRP from the configured reference signal power.

In an example, for NR, the parameter ss-PBCH-BlockPower in SIB1 may be decoded as the reference signal power for both the serving and target cell (or neighbor cell) to derive the network node's TX power difference between the serving and target cell.

In another example, for LTE, the parameter referenceSignalPower in SIB2 may be decoded as the reference signal power for both the serving and target cell (neighbor cell) to derive the network node's TX power difference between the serving and target cell.

The apparatus may determine the target measurement report timing (i.e., the timing for sending a measurement report to the network for the target cell) for triggering the handover procedure according to the predicted handover event timing. For example, the target measurement report timing may be predicted by considering the target handover timing and the estimated processing duration of the handover procedures (the time from the apparatus sending the measurement report to handover completion). The apparatus may transmit the measurement repot with the predicted target cell information (i.e., the target cell for handover or cell reselection) at the predicted timing (i.e., the target measurement report timing) to the network node.

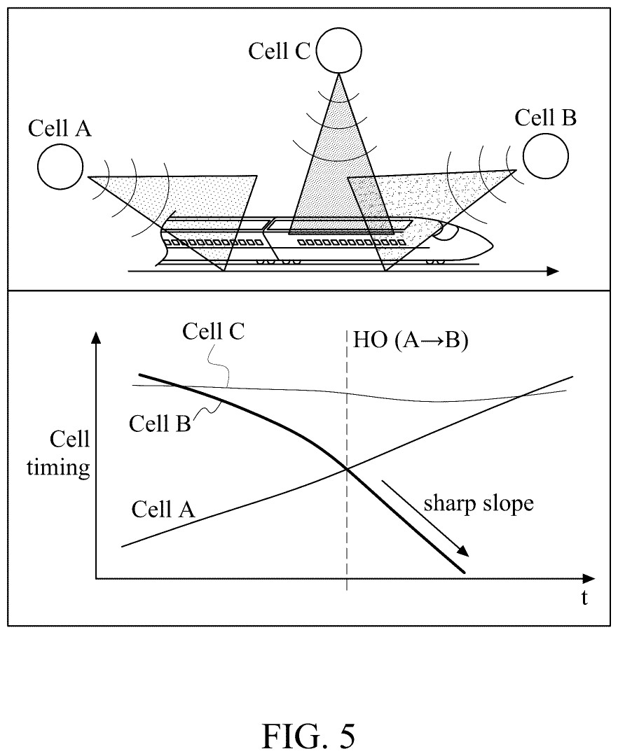

FIG. 5 is a schematic diagram illustrating a cell timing according to an embodiment of the invention. As shown in FIG. 5, after the velocity estimation, the apparatus may obtain the cell timing information (i.e., the result of the velocity estimation) corresponding to the cell A (e.g., serving cell), cell B (e.g., target cell) and the cell C (e.g., the cell for public network or a macro cell). As shown in FIG. 5, The cell timing of cell A is observed to be increasing over time, indicating that the distance between the apparatus and cell A is increasing. This observation corresponds to a positive and sharp slope in the cell timing value of cell A. Consequently, it can be inferred that the apparatus is moving away from cell A at a certain velocity. Conversely, the cell timing value of cell B is observed to be decreasing over time, indicating that the distance between the apparatus and cell B is decreasing. This observation corresponds to a negative and sharp slope in the cell timing value of cell B. Therefore, it can be inferred that the apparatus is approaching cell B (i.e., the target cell) at a certain velocity. In addition, the cell timing of the cell C corresponds to a flat slope and large delay. In the embodiment, when the apparatus performs the target cell prediction for handover or cell reselection, the apparatus can further concern the result of the velocity estimation for different cells (e.g., cell A, cell B and cell C) besides the signal quality information (e.g., RSRP, SINR or RSRQ) of the different cells. For example, when the apparatus performs the target cell prediction for handover or cell reselection, even if the signal quality of the cell C is better than the signal quality of cell B for a while, the apparatus may select the cell B as the target cell for handover or cell reselection since the cell timing of the cell B corresponds to a negative and sharp slope, and the cell timing of the cell B is decreasing over time. Therefore, according to the result of the velocity estimation, the apparatus can avoid the unnecessary handover (e.g., ping-pong handover), and the apparatus can determine the target cell for handover or cell reselection more accurately (e.g., the apparatus can find the precise handover timing after the handover prediction).

According to an embodiment of the invention, the operations of intra-frequency handover (HO) enhancement for the handover under connected mode are provided. In order to avoid unnecessary handovers (e.g., ping-pong handovers), the following methods may be concerned: (1) target cell prediction, (2) moving direction, (3) moving speed, (4) scenario detection, and (5) combinations of the aforementioned items.

In an implementation, the unnecessary handover (e.g., including ping-pong handover) avoidance based on the target cell prediction may involve adapting the parameters of measurement report evaluation to mitigate the effects of short-term RSRP/RSRQ/SINR fluctuations. Specifically, in an example, smaller A3 offset, smaller Time-to-Trigger (TTT), smaller hysteresis, or a combination of the above modifications may be applied when the A3 evaluation is performed on the intra-frequency neighbor cell predicted as the handover target cell. In another example, larger A3 offset, larger TTT, larger hysteresis, or a combination of the above modifications may be applied when the A3 evaluation is performed on the intra-frequency neighboring cell not predicted as the handover target cell. In another example, smaller A3 offset, smaller TTT, smaller hysteresis, or a combination of the above modifications may be applied when the A3 evaluation is performed in an event that the serving cell is not predicted as the target cell. In another example, larger A3 offset, larger TTT, larger hysteresis, or a combination of the above modifications may be applied when the A3 evaluation is performed in an event that the serving cell is predicted as the target cell. If the serving and all intra-frequency neighboring cells with RSRP and/or SINR above a predefined threshold are not predicted as the target cell, the apparatus may refer to the inter-frequency handover and scheduling enhancement below.

In another implementation, the unnecessary handover (e.g., ping-pong handover) avoidance based on the moving direction may involve adapting the parameters of measurement report evaluation to mitigate the effects of short-term RSRP/RSRQ/SINR fluctuations. Specifically, in an example, smaller A3 offset, smaller TTT, smaller hysteresis, or a combination of the above modifications may be applied when the A3 evaluation is performed on the intra-frequency neighboring cell which the apparatus is moving toward. In another example, larger A3 offset, larger TTT, larger hysteresis, or a combination of these modifications may be applied when the A3 evaluation is performed on the intra-frequency neighboring cell which the apparatus is moving away from. In another example, smaller A3 offset, smaller TTT, smaller hysteresis, or a combination of the above modifications may be applied when the A3 evaluation is performed in an event that the apparatus is moving away from the serving cell. In another example, larger A3 offset, larger TTT, larger hysteresis, or a combination of these modifications may be applied when the A3 evaluation is performed and the apparatus is moving toward the serving cell. If the apparatus is moving away from the serving and all intra-frequency neighboring cells with RSRP and/or SINR above a predefined threshold, the apparatus may refer to the inter-frequency handover and scheduling enhancement below.

In another implementation, the unnecessary handover (e.g., ping-pong handover) avoidance based on the moving speed may involve adapting the parameters of measurement report evaluation to mitigate the effects of short-term RSRP/RSRQ/SINR fluctuations. Specifically, in an example, when the apparatus is under high mobility, smaller A3 offset, smaller TTT, smaller hysteresis, or a combination of these modifications, may be applied in an event that the A3 evaluation is performed on the intra-frequency neighboring cell. Conversely, when the apparatus is under low mobility, larger A3 offset, larger TTT, larger hysteresis, or a combination of these modifications may be applied in an event that the A3 evaluation is performed on the intra-frequency neighboring cell.

In another implementation, the unnecessary handover avoidance (e.g., ping-pong handover) based on the scenario detection may involve adapting the parameters of measurement report evaluation to mitigate the effects of short-term RSRP/RSRQ/SINR fluctuations. Specifically, in an example, for scenario (1), where the apparatus is moving along fixed trajectories (e.g., high-speed train, train, subway, highway), smaller A3 offset, smaller TTT, smaller hysteresis, or a combination of these modifications, may be applied in an event that the A3 evaluation is performed on the intra-frequency neighboring cell identified as an along-fixed-trajectory cell. In another example, larger A3 offset, larger TTT, larger hysteresis, or a combination of these modifications may be applied when the A3 evaluation is performed on the intra-frequency neighboring cell identified as a non-along-fixed-trajectory cell.

In another implementation, the unnecessary handover (e.g., ping-pong handover) avoidance based on the combinations of the previously mentioned methods. For instance, the moving direction and the moving speed can be jointly considered to enhance handover decision-making. Specifically, in an example, smaller A3 offset, smaller TTT, smaller hysteresis, or a combination of the above modifications may be applied when the A3 evaluation is performed on the intra-frequency neighboring cell which the apparatus is moving toward with a higher relative velocity (i.e., v×cos θ) as compared to the intra-frequency neighboring cell which the apparatus is moving toward with a lower relative velocity (i.e., v×cos θ). In another example, larger A3 offset, larger TTT, larger hysteresis, or a combinations of the above modifications may be applied when the A3 evaluation is performed on the intra-frequency neighboring cell which the apparatus is moving away from with a higher relative velocity (i.e., v×cos θ) as compared to the intra-frequency neighboring cell which the apparatus is moving away from with a lower relative velocity (i.e., v×cos θ). In another example, if the apparatus is moving away from the serving cell with a higher relative velocity (i.e., v×cos θ), smaller modifications may be applied, and if the apparatus is moving toward the serving cell with a higher relative velocity (i.e., v×cos θ), larger modifications may be applied. In another example, smaller A3 offset, smaller TTT, smaller hysteresis, or a combination of these modifications may be applied when the A3 evaluation is performed in an event that the apparatus is moving away from the serving cell with a higher relative velocity (i.e., v×cos θ) as compared to with a lower relative velocity (i.e., v×cos θ). In another example, larger A3 offset, larger TTT, larger hysteresis, or a combination of the above modifications may be applied when the A3 evaluation is performed in an event that the apparatus is moving toward the serving cell with a higher relative velocity (i.e., v×cos θ) as compared to with a lower relative velocity (i.e., v×cos θ).

According to an embodiment of the invention, the apparatus may adaptively adjust the parameters of measurement report evaluation based on the handover timing prediction results which can derived according to the result of the velocity estimation previously described. The adjustment can reduce the inappropriate handover timing due to short-term RSRP/RSRQ/SINR fluctuations. Specifically, the apparatus may be configured to send the A3 report for the intra-frequency target cell at the target measurement report timing as outlined in the earlier sections.

According to an embodiment of the invention, adaptive radio resource management (RRM) measurement scheduling may be achieved through the following methods, (1) target cell prediction and handover timing prediction, (2) moving direction, (3) moving speed, (4) scenario detection, and (5) combinations of the aforementioned items.

In an implementation, for the adaptive RRM measurement scheduling based on the target cell prediction and the handover timing prediction, the apparatus may adaptively schedule measurements for RRM to save power without compromising mobility robustness. Specifically, the apparatus may increase the period between two consecutive measurements for intra-frequency and/or inter-frequency measurements if the serving cell is predicted as the target cell and/or the predicted handover timing is longer than a predefined threshold.

In another implementation, for the adaptive RRM measurement scheduling based on the moving direction, the apparatus may increase the period between two consecutive measurements for intra-frequency and/or inter-frequency measurements if the apparatus is moving toward the serving cell with RSRP and/or SINR above a predefined threshold. In addition, the apparatus may decrease the period between two consecutive measurements for the intra-frequency measurement if the apparatus is moving toward an intra-frequency neighboring cell with RSRP and/or SINR above a predefined threshold. In addition, the apparatus may decrease the period between two consecutive measurements for the inter-frequency and/or inter-RAT measurement if the apparatus is moving away from the serving cell and all the intra-frequency neighboring cells with RSRP and/or SINR above a predefined threshold.

In another implementation, for the adaptive RRM measurement scheduling based on the moving speed, the apparatus may increase the period between two consecutive measurements for intra-frequency and/or inter-frequency measurements when under low mobility. In addition, a larger interval between two consecutive measurements may be used if the apparatus is not moving away from the serving cell, the RSRP/SINR of the serving cell is above a predefined threshold, or the RSRP/SINR difference between the serving and the source cell is below a predefined threshold.

In another implementation, for the adaptive RRM measurement scheduling based on the scenario detection, the apparatus may decrease the period between two consecutive measurements for the inter-frequency and/or inter-RAT measurements with an along-fixed-trajectory cell detected, provided no along-fixed-trajectory cell with RSRP and/or SINR above a predefined threshold is detected within intra-frequency.

In another implementation, for the adaptive RRM measurement scheduling based on the combinations of the aforementioned items, when considering both moving direction and moving speed, a smaller interval between two consecutive measurements may be used for intra-frequency measurements if the apparatus is moving away from the serving cell with a higher relative velocity (i.e., v×cos θ) compared to a lower relative velocity (i.e., v×cos θ). Similarly, a smaller interval between two consecutive measurements is used for intra-frequency measurements if the apparatus is moving toward an intra-frequency neighboring cell with a higher relative velocity (i.e., v×cos θ) compared to a lower relative velocity (i.e., v×cos θ).

According to an embodiment of the invention, the L1/L3 filtering adaptation based on the moving speed may involve the apparatus adaptively adjusting the parameters of L1 and L3 filtering for measurement report evaluation. This is, the speed estimation results may be used to mitigate unnecessary handovers and handover failures for the signal fluctuations and measurement response delays. Specifically, in an example, under low mobility, the apparatus may apply the smooth filtering with larger bandwidth for L1 and/or L3 filtering to cope with short-term RSRP/RSRQ/SINR fluctuations. In another example, under high mobility, the apparatus may apply the smooth filtering with smaller bandwidth for L1 and/or L3 filtering to reduce measurement response delays.

According to an embodiment of the invention, for adaptive data transmission scheduling in application layers, the handover event indicators may be passed from the modem to the application processor (AP). Then, the AP may adaptively schedule data transmission based on the predicted handover timing to minimize the impact of interruptions caused by handover.

According to an embodiment of the invention, when an intra-frequency coverage hole or weak field is detected and the apparatus is moving away from the serving cell, the apparatus may use one of three operating modes for inter-frequency/inter-RAT measurement based on the target cell prediction, the moving direction, the weak field and coverage hole prediction, the control from AP or modem, or the combinations of the aforementioned items.

In an implementation for the Mode-1 (modem only), for the RRM measurement scheduling, the apparatus may modify the period between two consecutive measurements for inter-frequency/inter-RAT measurement based on the following strategies. The strategies may comprise two measurement scenarios. In the first measure scenario, the apparatus may decrease the period between two consecutive measurements for inter-frequency/inter-RAT measurement at the inter-frequency/inter-RAT configured by the network node in the measurement object. In the second measurement scenario, the apparatus may initiate inter-frequency/inter-RAT measurement at the inter-frequency/inter-RAT not configured by the network node. The strategies may comprise two operations. In the first operation, the apparatus may self-trigger Radio Link Failure (RLF) for re-establishment to try to camp on the inter-frequency/inter-RAT target cell. In the second operation, if the target cell at the inter-frequency/inter-RAT configured by the network node is a suitable handover target cell, the apparatus may apply larger A2 threshold, smaller A4 threshold, larger A5 threshold1, smaller A5 threshold 2, smaller TTT, and smaller hysteresis, or a combination of these modifications in an event that the A2/A4/A5 evaluation is performed to trigger inter-frequency handover. Similarly, if the target cell at the inter-RAT configured by the network node is a suitable handover target, the apparatus may apply smaller B1 threshold, smaller TTT, and smaller hysteresis, or a combination of the above modifications in an event that the B1 evaluation is performed to trigger inter-RAT handover. For the first measurement scenario, either the first operation or the second operation may be applied. For example, if no target cell at inter-frequency/inter-RAT configured by the network node is a suitable handover target cell, and if the target cell at inter-frequency/inter-RAT not configured by the network node is a suitable handover target cell, the apparatus may trigger the RLF to perform the network search. For the second measurement scenario, the first operation may be applied.

In an implementation for the Mode-2 (AP-assisted adaptive measurement), the modem may pass the weak field and coverage hole indicators to the AP to decide whether to decrease the period between two consecutive RRM measurements at inter-frequency configured by the network node and those not configured by the network node, and whether to follow the operations as indicated in the Mode-1.

In an implementation for the Mode-3 (AP-assisted UE self-trigger RLF), the modem may pass the weak field and coverage hole indicators and/or intra-frequency/inter-frequency/inter-RAT measurement results to the AP to decide whether to trigger RLF to perform the network search.

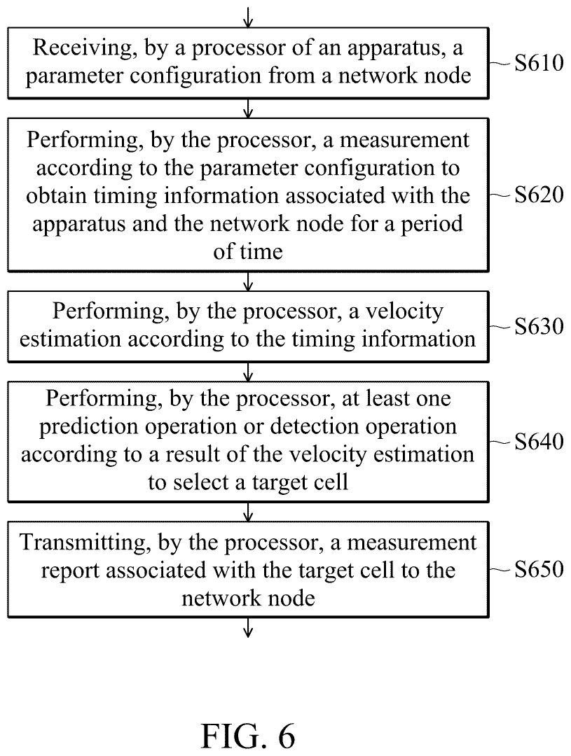

FIG. 6 is a flow chart illustrating a cell detection method according to an embodiment of the invention. The cell detection method can be applied in the communication apparatus 120 of the wireless communication system 100 and the communication apparatus 200. As shown in FIG. 6, in step S610, a processor of the communication apparatus 120 may receive a parameter configuration from a network node via a transceiver of the communication apparatus 120.

In step S620, the processor of the communication apparatus 120 may perform a measurement according to the parameter configuration to obtain timing information associated with the apparatus and the network node for a period of time.

In step S630, the processor of the communication apparatus 120 may perform a velocity estimation according to the timing information.

In step S640, the processor of the communication apparatus 120 may perform at least one prediction operation or detection operation according to a result of the velocity estimation to select a target cell.

In step S650, the processor of the communication apparatus 120 may transmit a measurement report associated with the target cell to the network node via the transceiver of the communication apparatus 120.

According to an embodiment of the invention, in the cell detection method, the timing information may comprise at least one of a DL signal received timing, a UL timing advance and a Doppler shift.

According to an embodiment of the invention, in the cell detection method, the result of the velocity estimation may comprise a speed magnitude, a moving direction and a slope information.

According to an embodiment of the invention, in the cell detection method, the at least one prediction operation may comprise a weak field prediction and a coverage hole prediction.

According to an embodiment of the invention, in the cell detection method, the at least one detection operation may comprise scenario detection, wherein a result of the scenario detection comprises a fixed trajectory scenario or a non-fixed trajectory scenario.

According to an embodiment of the invention, in the cell detection method, the at least one prediction operation may comprise a target cell prediction for a handover or a cell reselection.

According to an embodiment of the invention, in the cell detection method, the processor of the communication apparatus 120 may perform the target cell prediction according to the result of the velocity estimation, the result of the scenario detection and signal quality information. The signal quality information may comprise at least one of an RSRP value, an RSRQ value, and an SINR value.

According to an embodiment of the invention, in the cell detection method, the processor of the communication apparatus 120 may perform a timing prediction for the handover or the cell reselection.

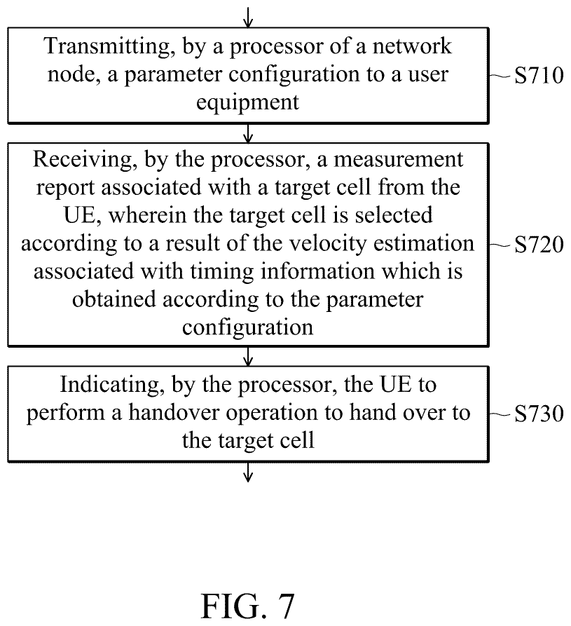

FIG. 7 is a flow chart illustrating a cell detection method according to an embodiment of the invention. The cell detection method can be applied in the network node 110 of the wireless communication system 100 and the network node 300. As shown in FIG. 7, in step S710, a processor of the network node 110 may transmit a parameter configuration to a user equipment via a transceiver of the network node 110.

In step S720, the processor of the network node 110 may receive a measurement report associated with a target cell from the UE via the transceiver of the network node 110, wherein the target cell may be selected according to a result of the velocity estimation associated with timing information which is obtained according to the parameter configuration.

In step S730, the processor of the network node 110 may indicate the UE to perform a handover operation to hand over to the target cell.

According to an embodiment of the invention, in the cell detection method, the timing information comprises at least one of a DL signal received timing, a UL timing advance and a Doppler shift.

According to an embodiment of the invention, in the cell detection method, the result of the velocity estimation comprises a speed magnitude, a moving direction and a slope information.

According to an embodiment of the invention, in the cell detection method, the processor of the network node 110 may transmit power information to the UE through a SIB for a timing prediction of the handover via the transceiver of the network node 110.

In the cell detection method provided in the embodiments of the invention, the apparatus can perform the velocity estimation according to the signal timing and Doppler spectrum, and perform the weak fields and coverage holes prediction, and the movement scenarios detection according to the result of the velocity estimation to improve mobile network connectivity. In addition, according to the cell detection method provided in the embodiments of the invention, the apparatus may perform the enhancement strategies for handover, reselection, and measurement scheduling to reduce the issues such as ping-pong handovers, too-late handovers, and handover or RLF. Therefore, the overall mobility robustness can be improved.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A cell detection method, comprising:
receiving, by a processor of an apparatus, a parameter configuration from a network node;
performing, by the processor, a measurement according to the parameter configuration to obtain timing information associated with the apparatus and the network node for a period of time;
performing, by the processor, a velocity estimation according to the timing information;
performing, by the processor, at least one prediction operation or detection operation according to a result of the velocity estimation to select a target cell; and
transmitting, by the processor, a measurement report associated with the target cell to the network node.

2. The cell detection method of claim 1, wherein the timing information comprises at least one of a downlink (DL) signal received timing, an uplink (UL) timing advance and a Doppler shift.

3. The cell detection method of claim 1, wherein the result of the velocity estimation comprises a speed magnitude, a moving direction and a slope information.

4. The cell detection method of claim 1, wherein the at least one prediction operation comprises a weak field prediction and a coverage hole prediction.

5. The cell detection method of claim 1, wherein the at least one detection operation comprises scenario detection, wherein a result of the scenario detection comprises a fixed trajectory scenario or a non-fixed trajectory scenario.

6. The cell detection method of claim 5, wherein the at least one prediction operation comprises a target cell prediction for a handover or a cell reselection.

7. The cell detection method of claim 6, further comprising:
performing, by the processor, the target cell prediction according to the result of the velocity estimation, the result of the scenario detection and signal quality information,
wherein the signal quality information comprises at least one of a reference signal received power (RSRP) value, a reference signal received quality (RSRQ) value, and a signal to interference plus noise ratio (SINR) value.

8. The cell detection method of claim 6, further comprising:
performing, by the processor, a timing prediction for the handover or the cell reselection.

9. An apparatus for cell detection, comprising:
a transceiver, wirelessly communicating with a network node; and
a processor, coupled to the transceiver and configured to:
receive, via the transceiver, a parameter configuration from the network node;
perform a measurement according to the parameter configuration to obtain timing information associated with the apparatus and the network node for a period of time;
perform a velocity estimation according to the timing information;
perform at least one prediction operation or detection operation according to a result of the velocity estimation to select a target cell; and
transmit, via the transceiver, a measurement report associated with the target cell to the network node.

10. The apparatus of claim 9, wherein the timing information comprises at least one of a downlink (DL) signal received timing, an uplink (UL) timing advance and a Doppler shift.

11. The apparatus of claim 9, wherein the result of the velocity estimation comprises a speed magnitude, a moving direction and a slope information.

12. The apparatus of claim 9, wherein the at least one prediction operation comprises a weak field prediction and a coverage hole prediction.

13. The apparatus of claim 9, wherein the at least one detection operation comprises scenario detection, wherein a result of the scenario detection comprises a fixed trajectory scenario or a non-fixed trajectory scenario.

14. The apparatus of claim 13, wherein the at least one prediction operation comprises a target cell prediction for a handover or a cell reselection.

15. The apparatus of claim 14, wherein the processor is further configured to:
perform the target cell prediction according to the result of the velocity estimation, the result of the scenario detection and signal quality information,
wherein the signal quality information comprises at least one of a reference signal received power (RSRP) value, a reference signal received quality (RSRQ) value, and a signal to interference plus noise ratio (SINR) value.

16. The apparatus of claim 14, further comprising:
perform a timing prediction for the handover or the cell reselection.

17. A cell detection method, comprising:
transmitting, by a processor of a network node, a parameter configuration to a user equipment;
receiving, by the processor, a measurement report associated with a target cell from the UE, wherein the target cell is selected according to a result of the velocity estimation associated with timing information which is obtained according to the parameter configuration; and
indicating, by the processor, the UE to perform a handover operation to hand over to the target cell.

18. The cell detection method of claim 17, wherein the timing information comprises at least one of a downlink (DL) signal received timing, an uplink (UL) timing advance and a Doppler shift.

19. The cell detection method of claim 17, wherein the result of the velocity estimation comprises a speed magnitude, a moving direction and a slope information.

20. The cell detection method of claim 17, wherein the processor is further configured to:
transmitting, by the processor, power information to the UE through a system information block (SIB) for a timing prediction of the handover.
